(19) United States
(12) Patent Application Publication
(10) Pub. No.: US 2008/0304193 A1
(43) Pub. Date: Dec. 11, 2008

(54) Voltage input circuit

(75) Inventor: Po-Yuan Shih, Taipei (TW)

Correspondence Address: BACON & THOMAS, PLLC, 625 SLATERS LANE, FOURTH FLOOR, ALEXANDRIA, VA, 22314-1176, US

(73) Assignee: INVENTEC CORPORATION, Taipei (TW)

(21) Appl. No.: 11/808,027

(22) Filed: Jun. 6, 2007

(51) Int. Cl. H02H 3/08; H02H 3/02

(52) U.S. Cl. 361/86

(57) ABSTRACT

The present invention is to provide a voltage input circuit applied to a notebook computer, which includes a first voltage terminal for receiving and outputting voltage, a first protection loop connected to the first voltage terminal and a second voltage terminal, a second protection loop connected between the first protection loop and the second voltage terminal, and a discharge loop connected between the second protection loop and the second voltage terminal. When a short condition occurs in the notebook computer, the first protection loop electrically cuts the connection between the first and second voltage terminals and outputs voltage to the discharge loop through the second protection loop, so as to prevent circuits or electronic components in the notebook computer from being burned or damaged.

### FIELD OF THE INVENTION

The present invention relates to a voltage input circuit, and more particularly to a voltage input circuit of an note book.

### BACKGROUND OF THE INVENTION

To operate an electronic product successfully anytime and anywhere, it is necessary to overcome a voltage supply issue of the design and development of various electronic products. Regardless of home electric appliances or portable electronic devices, a voltage supply is required for their operations. Particularly for portable electronic devices, it is necessary to have a design of supplying sufficient voltage to the devices all the time anywhere, and thus a perfect circuit design for inputting or converting voltage is required to ensure that the portable electronic devices can receive voltage safely. In addition, it is necessary to prevent an abnormal loop caused by a short condition of a circuit board of a portable electronic device due to water, dust, or other factors, since a surge current usually has an adverse impact on the electronic components of the circuit board or damages the circuit or electronic components. Therefore, some manufacturers provide a protection circuit to prevent short conditions.

Referring to FIG. 1 for a protection circuit applied to an electronic device, the protection circuit comprises a switch chip 100 and a comparator 102. The switch chip 100 is disposed between a voltage input terminal 12 and a working circuit 14 of the electronic device. The voltage input terminal 12 is provided for receiving and outputting voltage for the operation of the electronic device. The comparator 102 is coupled separately to the voltage input terminal 12 and the switch chip 100. If the voltage inputted from the voltage input terminal 12 is higher than a predetermined voltage in the comparator 102, then the comparator 102 will continue outputting a control signal to switch chip 100, such that the switch chip 100 will conduct the voltage input terminal 12 and the working circuit 14, and the voltage will be outputted to the electronic device. If a short condition occurs in the electronic device, then the current will be increased and the voltage will be decreased. If the voltage is lower than the predetermined voltage, then the comparator 102 will interrupt outputting the control signal to the switch chip 100 and disconnect the voltage input terminal 12 and the working circuit 14. Therefore, the voltage will not be outputted to the electronic device to prevent the increased current from damaging a circuit or an electronic component.

Although the aforementioned protection circuit can interrupt outputting the voltage to the electronic device when a short condition occurs in the electronic device, the comparator 102 still receives the voltage transmitted from the voltage input terminal 12. If the voltage received by the comparator 102 is higher than the predetermined voltage, then the comparator 102 will continue outputting a control signal to the switch chip 100. So that the switch chip 100 will conduct the voltage input terminal 12 and the working circuit 14, and continue outputting the voltage to the electronic device. Since a short condition has already occurred in the electronic device by then, an increase of current and a decrease voltage will recur. If the voltage is still lower than the predetermined voltage, the comparator 102 will interrupt outputting the control signal to the switch chip 100 to disconnect the voltage input terminal 12 and the working circuit 14. Therefore, the switch chip 100 switches the electronic device between a conducting status and an interrupt status repeatedly, and finally the increased current will damage a circuit or an electronic component of the electronic device.

### SUMMARY OF THE INVENTION

In view of the foregoing shortcomings of the prior art protection circuit that cannot thoroughly prevent an increased current from damaging a circuit or an electronic component of an electronic device, the inventor of the present invention based on years of experience in the related industry to conduct extensive researches and experiments, and finally developed a voltage input circuit in accordance with the present invention.

It is a primary objective of the present invention to provide a voltage input circuit, and the voltage input circuit is applied to a notebook computer. The voltage input circuit comprises a first voltage terminal separately coupled to a first protection loop and a second protection loop, and a first protection loop and a second protection loop are coupled separately to a second voltage terminal, and a discharge loop is coupled between the second protection loop and the second voltage terminal. The first voltage terminal is provided for receiving and outputting voltage, and the second voltage terminal is provided for receiving voltage outputted from the first voltage terminal and outputting the voltage to the notebook computer. If no short condition occurs in the electronic device, the first protection loop will conduct the first voltage terminal and the second voltage terminal, such that the voltage will be outputted to the notebook computer through the first protection loop and the second voltage terminal. If a short condition occurs in the electronic device, the first protection loop will electrically cut the connection between the first voltage terminal and the second voltage terminal, so that the voltage will be outputted to the discharge loop through the second protection loop. Therefore, an increase of current and a decrease of voltage will not recur, so as to prevent an increased current from damaging a circuit or an electronic component of the notebook computer.

To make it easier for our examiner to understand the objective, technical characteristics and effects of the present invention, preferred embodiment will be described with accompanying drawings as follows:

### BRIEF DESCRIPTION OF THE DRAWINGS

FIG. 1 is a schematic view of a conventional protection circuit;

FIG. 2 is a schematic view of a voltage input circuit of the present invention; and

FIG. 3 is a circuit diagram of a voltage input circuit of the present invention.

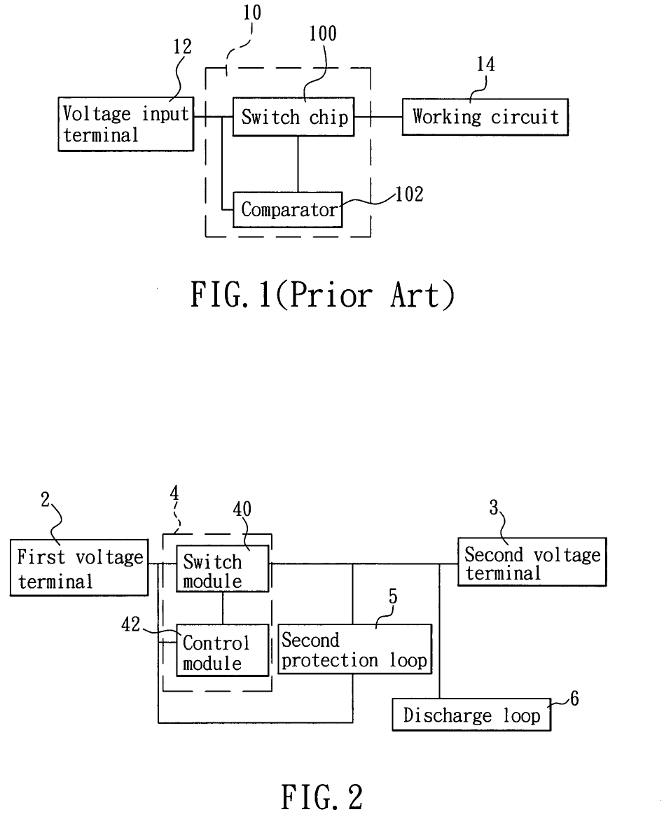

### DETAILED DESCRIPTION OF THE PREFERRED EMBODIMENTS

Referring to FIG. 2 for a schematic view of a voltage input circuit of the invention, the voltage input circuit is applied to a notebook computer. The voltage input circuit comprises a first voltage terminal 2, a second voltage terminal 3, a first protection loop 4, a second protection loop 5 and a discharge loop 6. The first voltage terminal 2 is provided for receiving voltage outputted from the voltage input circuit, and outputting the voltage to the voltage input circuit. The second voltage terminal 3 is provided for receiving the voltage outputted by the first voltage terminal 2 and outputting the received voltage to the notebook computer, such that the notebook computer can receive the voltage for its operation. The first protection loop 4 comprises a switch module 40 and a control module 42. The switch module 40 is disposed between the first voltage terminal 2 and the second voltage terminal 3, and the control module 42 is coupled separately to the first voltage terminal 2 and the switch module 40. An input terminal of the second protection loop 5 is coupled between the first voltage terminal 2 and the control module 42, and an output terminal of the second protection loop 5 is coupled between the switch module 40 and the second voltage terminal 3. The discharge loop 6 is coupled to an output terminal of the second protection loop 5 and the second voltage terminal 3.

If no short condition occurs in the electronic device, then the voltage received by the control module 42 will be compliant with a predetermined voltage in the control module 42, and the control module 42 will keep conducting the switch module 40, so that the voltage received by the first voltage terminal 2 can be transmitted to the notebook computer through the second voltage terminal 3. If a short condition occurs in the electronic device, then the current will be increased and the voltage will be decreased, and thus the voltage received by the control module 42 will be incompliant with the predetermined voltage, and the control module 42 will disconnect the switch module 40, and voltage incompliant with the predetermined voltage cannot be transmitted to the second voltage terminal 3 through the switch module 40, but the voltage is transmitted to the discharge loop 6 through the second protection loop 5 for an electric discharge. The invention not only avoids the recurrence of increasing the current and decreasing the voltage, but also transmits the voltage that is incompliant with the predetermined voltage to the discharge loop 6, so as to prevent an increased current from damaging a circuit or an electronic component of the notebook computer.

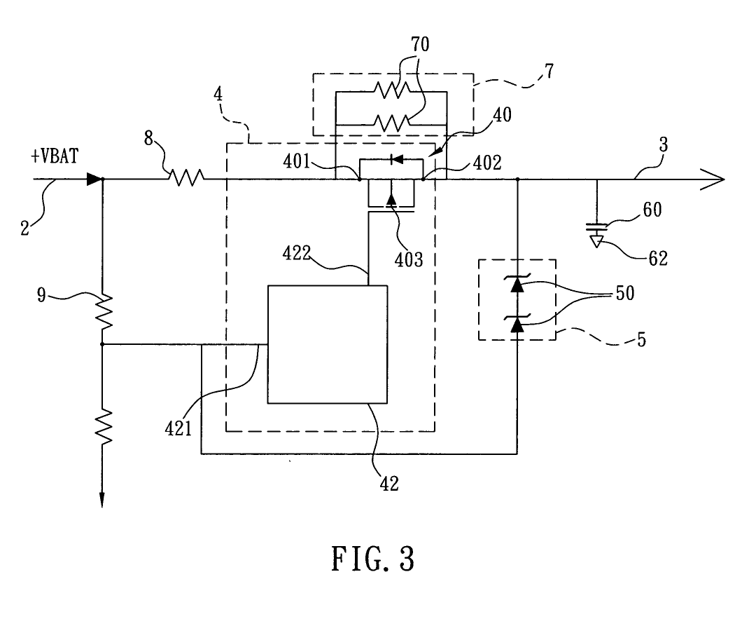

Referring to FIGS. 2 and 3 for a preferred embodiment of the present invention, the second protection loop 5 installs at least one Zener diode 50, such that if no short condition occurs in the electronic device, the voltage passing through the switch module 40 is prevented from being transmitted to the control module 42 through the second protection loop 5. If a short condition occurs in the electronic device, voltage incompliant with the predetermined voltage will be outputted to the discharge loop 6 through the Zener diode 50 continuously to prevent an increased current from impacting a circuit or an electronic component of the notebook computer.

In the preferred embodiment as shown in FIG. 3, the control module 42 comprises a voltage receiving pin 421 and an electric conduction pin 422. The voltage receiving pin 421 is coupled between a first voltage terminal 2 and a Zener diode 50, for receiving the voltage transmitted from the first voltage terminal 2. If the voltage received by the voltage receiving pin 421 is incompliant with the predetermined voltage, then the control module 42 will continue generating an electric conduction signal. The electric conduction pin 422 is coupled to the switch module 40, and the electric conduction signal is transmitted to the switch module 40 through the electric conduction pin 422, so that the switch module 40 can be controlled to conduct the first voltage terminal 2 and the second voltage terminal 3, or the switch module 40 can be controlled to cut the connection between the first voltage terminal 2 and the second voltage terminal 3.

In the preferred embodiment as shown in FIG. 3, the switch module 40 is a metal oxide semiconductor field effect transistor (MOSFET). The switch module 40 comprises a first pin 401, a second pin 402 and a control pin 403. The first pin 401 is coupled to the first voltage terminal 2 for receiving a voltage transmitted from the first voltage terminal 2, and the second pin 402 is coupled to the second voltage terminal 3 for outputting the voltage transmitted from the first voltage terminal 2 to the second voltage terminal 3. The control pin 403 is coupled to the electric conduction pin 422. If the control pin 403 continues receiving an electric conduction signal, the first pin 401 and the second pin 402 will be conduced continuously, and the voltage will be transmitted to the second voltage terminal 3 through the switch module 40. If the control pin 403 has not received an electric conduction signal, the first pin 401 and the second pin 402 will be disconnected, and the voltage cannot be transmitted to the second voltage terminal 3 through the switch module 40.

In the preferred embodiment as shown in FIGS. 2 and 3, the discharge loop 6 comprises a capacitor 60 and a ground terminal 62. The capacitor 60 is coupled between an output terminal of the second protection loop 5 and the second voltage terminal 3, and the ground terminal 62 is coupled to the capacitor 60. Therefore, a surge voltage transmitted to the voltage input circuit can be absorbed by the capacitor 60 to prevent the unstable voltage from impacting a circuit or an electronic component of the notebook computer. If a short condition occurs in the electronic device, the voltage will pass through the capacitor 60. If the capacitor 60 is fully charged, the voltage will be outputted to the ground terminal 62 for an electric discharge to prevent a circuit or an electronic component of the notebook computer from being damaged.

In the preferred embodiment as shown in FIG. 3, the voltage input circuit further comprises a current limit loop 7. An input terminal of the current limit loop 7 is coupled between the first voltage terminal 2 and the switch module 40, and an output terminal of the current limit loop 7 is coupled between the switch module 40 and the second voltage terminal 3, such that the current limit loop 7 and the switch module 40 are connected in parallel, so as to reduce the time for boosting the voltage received by the control module 42 to the predetermined voltage, and boot a notebook computer in a shorter time. Further, the current limit loop 7 installs at least one resistor 70, or two resistors 70 connected in parallel with each other, such that the quantity of resistors 70 is controlled to select the time required for boosting the voltage received by the control module 42 to the predetermined voltage.

In the preferred embodiment as shown in FIG. 3, the voltage input circuit further comprises a first voltage divider 8 and a second voltage divider 9. The first voltage divider 8 is coupled between the first voltage terminal 2 and the first pin 401, and the second voltage divider 9 is coupled between the first voltage terminal 2 and the control module 42. With the first voltage divider 8 and the second voltage divider 9, voltage (such as 1.3 volt) is transmitted to the control module 42 and provided for the control module 42 to determine whether or not the received voltage exceeds the predetermined voltage (such as 1.2 volts).

In summation of the description above, the voltage input circuit of the invention can prevent an increase current from damaging a circuit or an electronic component of a notebook computer, if a short condition occurs in the electronic device. In addition, low-priced electronic components (such as resistor or Zener diode) are used for the voltage input circuit of the present invention, and the overall manufacturing cost for applying the voltage input circuit to a notebook computer is less than U.S. $0.009.

While the invention herein disclosed has been described by means of specific embodiments, numerous modifications and variations could be made thereto by those skilled in the art without departing from the scope and spirit of the invention set forth in the claims.

What is claimed is:

1. A voltage input circuit, applied to a notebook computer, and comprising:
a first voltage terminal, for receiving and outputting voltage;
a second voltage terminal, for receiving voltage outputted by said first voltage terminal, and outputting said voltage to said notebook computer;
a first protection loop including a switch module and a control module, wherein said switch module is disposed between said first voltage terminal and said second voltage terminal, and said control module is coupled separately to said first voltage terminal and said switch module, said control module electrically conducts said switch module to transmit voltage to said second voltage terminal when said control module receives said voltage outputted by said first voltage terminal and complying with a predetermined voltage of said control module;
a second protection loop having an input terminal coupled between said first voltage terminal and said control module and an output terminal coupled between said switch module and said second voltage terminal, and said control module cuts said switch module when said control module receives voltage outputted by said first voltage terminal and not complying with said predetermined voltage, and said voltage is transmitted to said second protection loop; and
a discharge loop, coupled between an output terminal of said second protection loop and said second voltage terminal, for receiving said voltage outputted by said second protection loop and not complying with said predetermined voltage.

2. The voltage input circuit of claim 1, wherein said second protection loop includes at least one Zener diode, for outputting voltage not complying with said predetermined voltage to said discharge loop through said Zener diode.

3. The voltage input circuit of claim 2, wherein said control module comprises:
a voltage receiving pin, coupled between said first voltage terminal and said Zener diode, for receiving voltage transmitted from said first voltage terminal; and
an electric conduction pin, coupled to said switch module, such that when said voltage received by said voltage receiving pin complies with said predetermined voltage, said control module generates an electric conduction signal and transmit said electric conduction signal to said switch module through said electric conduction pin.

4. The voltage input circuit of claim 3, wherein said switch module comprises:
a first pin, coupled to said first voltage terminal, for receiving said voltage;
a second pin, coupled to said second voltage terminal; and
a control pin, coupled to said electric conduction pin, for transmitting said electric conduction signal to said switch module and enabling said switch module to conduct said first pin and second pin.

5. The voltage input circuit of claim 4, wherein said discharge loop comprises:
a capacitor, coupled between an output terminal of said second protection loop and said second voltage terminal; and
a ground terminal, coupled to said capacitor.

6. The voltage input circuit of claim 5, further comprising a current limit loop having an input terminal coupled between said first voltage terminal and said switch module and an output terminal coupled between said switch module and said second voltage terminal.

7. The voltage input circuit of claim 6, wherein said current limit loop includes at least one resistor.

8. The voltage input circuit of claim 6, wherein said current limit loop includes two resistors connected parallel with each other.

9. The voltage input circuit of claim 4, further comprising:
a first voltage divider, coupled between said first voltage terminal and said first pin; and
a second voltage divider, coupled between said first voltage terminal and said control module.

10. The voltage input circuit of claim 4, wherein said switch module is a metal oxide semiconductor field effect transistor (MOSFET).
